(19) United States
(12) Patent Application Publication
(10) Pub. No.: US 2019/0166495 A1
(43) Pub. Date: May 30, 2019

(54) DEVICE AUTHENTICATION

(71) Applicant: Cable Television Laboratories, Inc., Louisville, CO (US)

(72) Inventors: Steven J. Goeringer, Westminster, CO (US); Darshak Thakore, Broomfield, CO (US); Massimiliano Pala, Denver, CO (US); Michael J. Glenn, Golden, CO (US); Brian A. Scriber, Denver, CO (US); Jason W. Rupe, Lafayette, CO (US)

(21) Appl. No.: 16/202,659

(22) Filed: Nov. 28, 2018

Related U.S. Application Data
(60) Provisional application No. 62/591,560, filed on Nov. 28, 2017.

(51) Int. Cl. H04W 12/06; G06F 21/44

(52) U.S. Cl. CPC H04W 12/0602; G06F 21/44

(57) ABSTRACT

Authenticating a device is contemplated. The authenticating may include generating an authentication sufficient to represent trust in an identity of a device when being provisioned or re-provisioned for network access, reconciling inventory management and/or otherwise performing operations dependent on trust.

### CROSS-REFERENCE TO RELATED APPLICATIONS

This application claims the benefit of U.S. provisional Application No. 62/591,560 filed Nov. 28, 2017, the disclosure of which is incorporated in its entirety by reference herein.

### TECHNICAL FIELD

The present invention relates to authenticating a device, such as but not necessarily limited to facilitating an authentication of trust in an identity of the device when being provisioned or re-provisioned for network access, reconciling inventory management and/or otherwise performing operations dependent on trust.

### BACKGROUND

Devices having communication capabilities may require provisioning, onboarding, programming or other configuring to establish network connectivity to wired and/or wireless networks, communication mediums, access points, peer devices, gateways, nodes, routers, etc. It may be desirable to determine an identity of the device prior to provisioning or otherwise directing or controlling operations of the device needed to establish such network conductivity. Masquerading and other subversive processes may be employed by illegitimate devices to obtain provisioning needed for network conductivity by stealing or otherwise inappropriately relying on the identity of a legitimate device. One non-limiting aspect of the present invention contemplates ameliorating the likelihood of illegitimate devices using an identity masquerade, theft or other misuse to obtain network connectivity using an authentication sufficient to assess trust in an identity of a device before instigating provisioning processes attestations to devices in manner adequate to thwart an illegitimate device from using the identity of the devices to illicitly establish network connectivity.

Inventory reconciliation may be periodically performed by network administrators and/or security engineers to assess/discover connection locations for devices in a network, how the devices are being used and for other management related purposes. Inventory reconciliation can be a human intensive process whereby individuals may be required to reconcile discrepancies between inventories generated when onboarding/provisioning devices for network connectivity with independent inventories subsequently generated from polling of the connected devices. While the contemplated authentication may be useful in establishing trust in an identity for purposes of thwarting illicit device provisioning, the trust gleaned from binding the attestations to devices may also be useful in reconciling discrepancies between the onboarding/provisioning inventories and the polling inventories with automated processes for physical verification and discovery processes derive from having the authentication of trust for devices.

### BRIEF DESCRIPTION OF THE DRAWINGS

FIG. 1 illustrates an authentication system in accordance with one non-limiting aspect of the present invention.

FIG. 2 illustrates a device having attestations in accordance with one non-limiting aspect of the present invention.

FIG. 3 illustrates a device having attestations in accordance with one non-limiting aspect of the present invention.

FIG. 4 illustrates a flowchart of a method for authenticating trust in an identity of a device in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

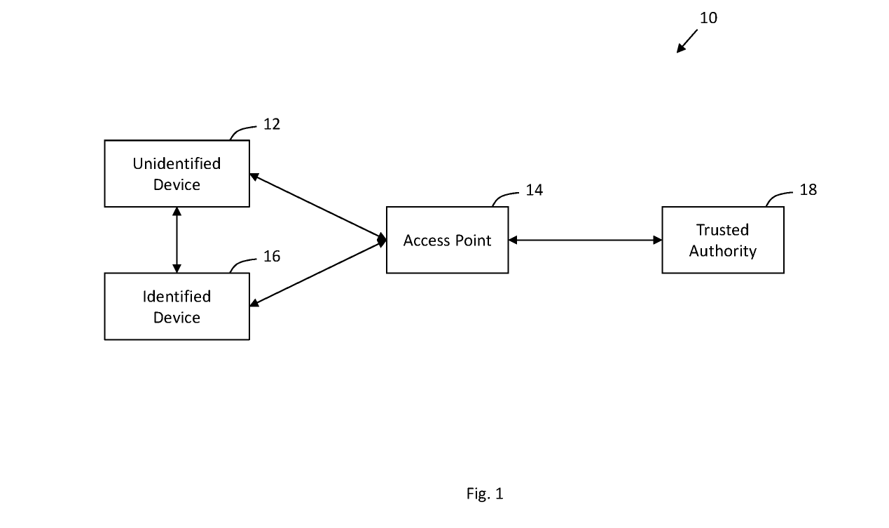

FIG. 1 illustrates an authentication system 10 in accordance with one non-limiting aspect of the present invention. The authentication system 10 may, for example, facilitate generating an authentication sufficient to enable administrators to confirm or ascertain trust in an identity being proffered by or otherwise obtained from a device 12. One non-limiting aspect of the present invention contemplates the authentication being determined prior to provisioning or otherwise directing or controlling operations of the device 12 needed to connect with wired and/or wireless network networks, communication mediums, peer devices, gateways, nodes, routers, etc., such as the exemplarily illustrated access point 14. The authentication may be determined prior to such events to thwart masquerading and other subversive processes employed by illegitimate devices to obtain provisioning needed for network conductivity by stealing or otherwise inappropriately relying on the identity of the device 12. While the present invention may be predominately described with respect to the authentication establishing trust in the identity of the device 12 prior to being provisioned for network conductivity, the present invention is not necessarily so limited and fully contemplates its use and application in facilitating other trust-dependent operations.

The device 12 requiring the authentication may be characterized for exemplary purposes as being unidentified as the device 12 may be similarly considered to be unauthenticated, untrusted or insufficiently known for purposes of a trust-dependent operation the device intends to undertake. The authentication may be facilitated with an another device 16 previously identified as having administrative, configurator status or another designation sufficient to indicate it having capabilities to facilitate onboarding, provisioning or otherwise configuring the unidentified device 12 for connection to the access point 14, which may be characterized for exemplary purposes as an identified device 16 for purposes of distinguishing its established trust from the unknow or unestablished trust of the unidentified device 12. While other provisioning protocols and processing may be contemplated to facilitate operations necessary for onboarding the unidentified device 12 to the access point 14 or to otherwise facilitate network connectivity, one non-limiting aspect of the present invention contemplates enabling the onboarding with a provisioning process whereby the unidentified device 12 and the identified device 16 and/or the access point 14 may exchange information needed for onboarding. The provisioning process may include a manual verification and an automated onboarding whereby the manual verification may be performed as a function of a user input or a user facilitated input to the identified device 16 verifying the access point 14 for onboarding, and the automated onboarding may occur with the identified device 16 and/or the access point 16 providing parameters to the unidentified device 12 needed for automatically onboarding with the access point 14, i.e., without corresponding user input of those parameters to the unidentified device 12.

One non-limiting aspect of the present invention contemplates an authentication process for providing an authentication sufficient to assess trust in an identity of the unidentified device 12. The authentication process may occur prior to the provisioning process and/or be included as part of the provisioning process, such as to facilitate establishing trust or a likelihood of trust in the unidentified device 12 being what it asserts to be before provisioning it for network conductivity or other trust-based operations, e.g., to determine the unidentified device 12 is the originally manufactured device or the device its operator understands it to be and not an illegitimate or subversive device attempting to masquerade or otherwise misuse an identity of another device. The authentication process for assessing trust in the unidentified device 12 may be performed in cooperation with virtually any provisioning process, including those that may not include automated onboarding, to facilitate or supplement trust determinations prior to or as part of decision-making processes undertaken before granting unidentified devices network conductivity or access to other services, including things such as building entry, device tracking, inventory reconciling, etc. The trust ascertained according to the processes contemplated herein may be facilitated through a binding process or an application process where attestations may be associated with devices 12 in manner sufficient to thwart an illegitimate device from using the identity of those attested devices 12 to illicitly establish network connectivity or otherwise subvert trust-based decision-making processes.

The application process may include associating one or more attestations with devices at a time of manufacture, purchase, deployment and/or at a time thereafter. Such associations may include after purchase from a retailer or at device installation whereby an entity having perceived trust, such as a manufacturer employee or installation technician, may facilitate associating attestations with devices 12 prior to the purchase of or customer deployment of the device 12 for use. The attestations may be associated, linked, or bound with the devices 12 in a manner sufficient to thwart illegitimate, illicit or subversive devices or individuals from obtaining those attestations or data generated therefrom for purposes of identifying themselves in a manner intended to masquerade or subvert provisioning as if the illegitimate devices were one of the devices 12 bound to an attestation. A trusted authority 18 may facilitate the application processes through generation, communication and/or maintenance of attestations associated with devices. The trusted authority 18 may optionally be part of or operate in cooperation with a certificate authority (CA) utilized in a public key infrastructure (PKI) to generate certificates, credentials, public keys, private keys, etc. to facilitate establishing trust in an identity for purposes of securing communications. The trusted authority 18 may optionally also be part of or operate in cooperation with other trusted certificate or key distribution entities, such as those associated with facilitating symmetric key encryption or other security operations where an authority operates independently of entities trying to established trust with each other, e.g., an independent authority that issues certificates, profiles, keys, etc. for purposes of enabling two or more entities to establish trust and/or security with each other. Possible systems that may utilize the present systems and methods include but not limited to PSK, PKI, virtual SIM (e.g., eSIM), etc.

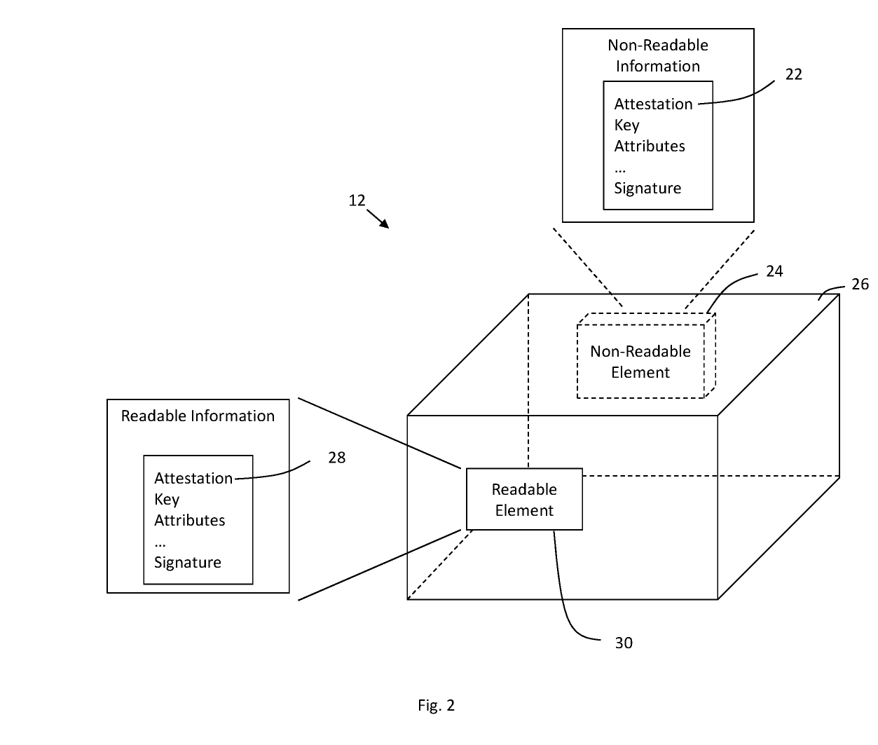

FIG. 2 illustrates the device 12 having attestations in accordance with one non-limiting aspect of the present invention. A binding may include the trusted authority 18 associating data or information with the device 12 in a manner intended to thwart other devices from masquerading or stealing identity from the device 12. The bound data, information, etc., which may be referred herein for exemplary purposes as an attestation, may be utilized in accordance with the present invention to facilitate proving trust or belief in the device 12. One attestation may be characterized as a non-readable attestation embedded 22 or otherwise included within a non-readable element 24 of the device 12. The non-readable element 24 may be a hardware component, a non-transitory computer-readable medium, firmware or other element included within a housing 26 of the device 12 or otherwise enclosed as part of the device 12, which absent deconstruction or teardown, may be effectively inaccessible to or unreadable with external devices. The non-readable element 24 may lack interfaces sufficient to enable exterior devices to optically, wirelessly or wiredly access its contents without sophisticated techniques requiring an associated chip, board, etc. to be physically removed and accessed. The device 12 may include additional interfaces to facilitate optical, wireless or wired communications, such as componentry sufficient to facilitate communicating with the identified device 16, trusted authority 18 or other external devices, whereby those interfaces may cooperate with a processor or other logically functioning element to facilitate programming the non-readable attestation 22 to the non-readable element 24 according to instructions received from the trusted authority 18. The non-readable attestation 22 may optionally also be hardwired or included as part of a chipset, silicone or wafer forming the non-readable element 24 such that it may be inalterable or non-programmable after a time of manufacture.

The device 12 may additionally include a readable attestation 28 within a readable element 30 of the device. The readable attestation may be bound to the readable element at the time of manufacture and/or thereafter, such as in response to instructions provided from the trusted authority 18, a network administrator, an exterior device or virtually any entity having access thereto. The readable element 30 may be a display, a user interface, a universal serial bus (USB) interface, a near-field communication (NFC) interface, a Bluetooth interface, an optically readable image (e.g., bar code, QR code, etc.) or other accessible interface, which aside from the optically readable image or other non-electrical communicator, may cooperate with a processor, memory or other componentry of the device 12. One non-limiting aspect of the present invention contemplates generating the authentication used to assess trust in an identity of the unidentified device 12 based in part on information collected from the readable element 30 using the identified device 16. In the exemplary context of the unidentified device 12 and the identified device 16, the readable attestation 28 may be differentiated from the non-readable attestation 22 in so far as the identified device 16 being unable to access or read the non-readable attestation 22 of the and being able to access or read the readable attestation 28. The content and/or information included as part of the readable and non-readable elements 22, 28, which may include additional information beyond the readable and non-readable attestations, may be differentiated according to access thereto, e.g., the readable element 30 may be accessible with the identified device 16 or another similar device whereas the non-readable element 24 may not be accessible to those devices.

The readable and non-readable attestations 22, 28 may be a number or series of bits uniquely assigned by the trusted authority 18 for binding to the device 12. The readable and non-readable attestations 22, 28 may also be other indicators, such as a certificate ID generated as part of a PKI process or a device ID generated as part of a manufacturing process, e.g., a serial number assigned at the time of manufacture. The readable and non-readable attestations 22, 28 may also be or include other values, such as a media access control (MAC) address, Internet protocol (IP) address, etc. sufficient to facilitate the authentication process contemplated herein. One non-limiting aspect of the present invention contemplates relying on the readable and non-readable attestations 22, 28 to facilitate assessing trust in an identity being proffered by the unidentified device 12 or other device attempting to access a service, network, etc. requiring trust prior to providing access thereto. Trust in an identity of the unidentified device 12 may be derived from a chain of control whereby the trusted authority 18 generates the readable and non-readable attestations 22, 28 to be identical, and assuming a sufficient level of control or security over how the identical, readable and non-readable attestations 22, 28 were added to the readable and non-readable elements 24, 30, the corresponding trust may be presumed when the readable attestation matches with the non-readable attestation 22, 28. The trust may be derived from the time of manufacturing or deployment, or other temporal interval when the readable and non-readable attestations 22, 28 were bound to the device 12, to indicate a sufficient probability of the device 12 having been uncompromised thereafter if the readable and non-readable attestations 22, 28 match.

An identicality of the of the readable and non-readable attestations 22, 28 may be beneficial in ameliorating processing and memory storage associated with tracking non-identical attestations 22, 28 for a number of devices. For example, such a process may require fewer resources when comparing identical, readable and non-readable attestations 22, 28 for a match relative to comparing non-identical, readable and non-readable attestations 22, 28. The use of non-identical, readable and non-readable attestations 22, 28 may be employed without deviating from the scope and contemplation of the present invention, such as by including a database or other tracking mechanism sufficient to generate a match or other correspondence between non-identical, readable and non-readable attestations 22, 28 of the type capable of forming an assessment as to whether the associated device 12 has been uncompromised since a time of attestation binding. The readable and non-readable attestations 22, 28 may be illustrated for exemplary purposes as being included on the readable and non-readable elements 24, 30 as a supplement to additional information thereon. The additional information may be used to facilitate operations of the device or for other purposes and may be differentiated according to the characteristics of the readable and non-readable elements 24, 30 in so far as the additional information included on the non-readable element 24 may be inaccessible to the identified device 16 or other external devices and the additional information included on the readable element 30 may be accessible to the identified device or other external devices.

The additional information included on the readable and non-readable elements 24, 30 may be used to facilitate device provisioning, e.g., the authentication may be used to establish trust in an identify of the device 12 based at least in part on the readable and non-readable attestations 22, 28, and if trust is established, the additional information included on the readable and non-readable elements 24, 30 may be used to facilitate provisioning. One provisioning process contemplated herein may facilitate automated provisioning whereby the unidentified device 12 may be automatically connected to the access point 14 or other service point without a user having to manually input connection parameters and other information to the unidentified device 12, optionally after manual verification is made through the identified device 16. The provisioning process may be facilitated with the identified device 16 or other device having configurator, administrative or other control over the access point, such as in accordance with the Device Provisioning Protocol (DPP) Specification, Version 1.0, published by the Wi-Fi Alliance, the disclosure of which is hereby incorporated in its entirety herein. DPP may provide a mechanism whereby the identified device 16 may obtain a public key, attributes and other data included as part of the additional information from the readable element for purposes of automatically provisioning the unidentified device 12 for connectivity with the access point 14.

An identity of the device 12 may correspond with one or more of the pieces of information included within the readable and/or non-readable elements 24, 30 capable of being distinguishing. The identity may be formed entirely from the contents of the attestations 22, 28, entirely from contents of a certificate or other identity information provided from the trusted authority 18, e.g., a PKI certificate or symmetric key profile, or some combination thereof, such as by combining the attestations 22, 28 with the PKI certificate or other identifying construct issued from the trusted authority 18, a manufacturer of the device 12, the service provider that the device 12 is attempting to access, etc. In the context of DPP or other provisioning, onboarding or accessing protocols relying on information from the readable element 30, the combined use of the readable and non-readable attestations 22, 28 may be beneficial in thwarting masquerading attacks whereby an illicit device scans or otherwise gains access to the information of the readable element 30 for purposes of using that information to provision itself for onboarding with the access point 14 as if it were another device and/or to trick a user of the identified device 16 or other device having administration capabilities into thinking they are authorizing another device other than the illicit device for onboarding using some or all of an identity taken from access to the readable element 30.

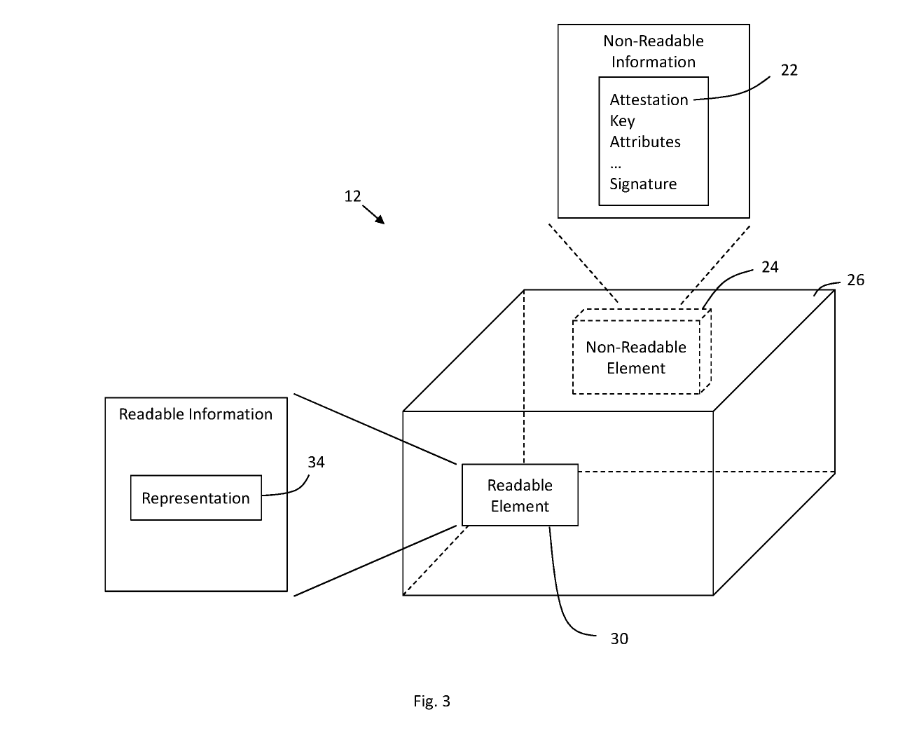

FIG. 3 illustrates the device 12 having attestations in accordance with one non-limiting aspect of the present invention. The binding may be similar to the binding described with respect to FIG. 2 in so far as utilizing the readable element 24 and the non-readable element 30 of the device 12 to facilitate access to one more attestations 22, 34 provided from the trusted authority 18. The binding may be differentiated from the binding described with respect to FIG. 2 in so far as the readable attestation 34 included on the readable element 30 being a signature of the non-readable attestation 22, and optionally some or all of the additional information, included on the non-readable element 24. The readable attestation 28 in FIG. 2 may be accessible to the identified device 16 along with the other information, certificate or profile from the readable element, such as in plaintext or other non-encrypted form, whereas the readable attestation 34 in FIG. 3 may in contrast be a digital signature or ciphertext generated from encoding of the non-readable attestation 22 or other information included within the non-readable element 24, e.g., credential, certificate, etc. The readable attestation 34 accessible through the readable element in FIG. 3 may correspondingly be a representation of the non-readable attestation 22 and/or other identity information included within the non-readable element 24.

The readable attestation 34 may be characterized as a representation for exemplary purposes to distinguish its use from the readable attestation 28 described with respect to FIG. 2. The representation 34 may be encrypted by the trusted authority 18 to prevent illicit devices from recovering the information encrypted therein, i.e., to thwart illicit devices from scanning or otherwise accessing the readable element 30 for purposes of ascertaining the attestation 34 and/or the identity related information thereon without approval from the trusted authority 18 or access to encryption keys utilized by the trusted authority 18. The trusted authority 18 may meter entities having access to the keys or other information needed to decrypt the representation 34 to provide additional measures of security and trust. Instead of providing decryption keys to the identified device 16, which could be intercepted by the illicit device in some instances, the trusted authority 18 may instead require the identified device 16 to communicate the representation 34 as read from the readable element 30 without decoding for the trusted authority 18 to independently authenticate as being unaltered. Relying on the trusted authority 18 to verify the representation/signature 34, may be beneficial in enabling the readable attestation 34 to be added at any time to the device 12 since it would be unlikely that an illicit device could generated a corresponding signature on its own, particularly if it lacks access to the encoded information, e.g., some or all of the information on the non-readable element 24.

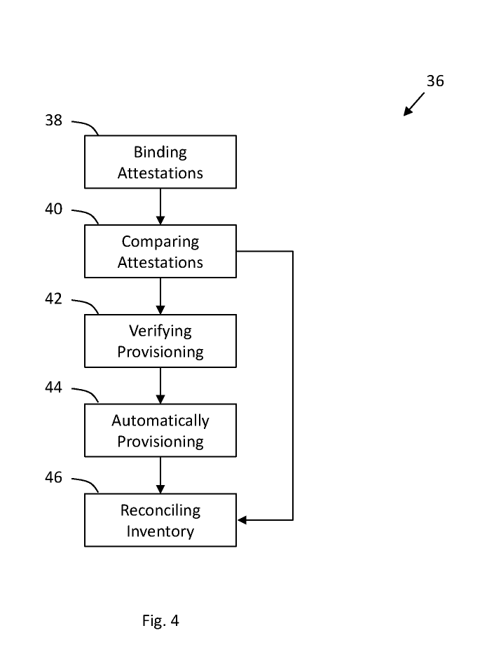

FIG. 4 illustrates a flowchart 36 of a method for authenticating trust in an identity of a device in accordance with one non-limiting aspect of the present invention. The method may include another device and trusted authority cooperating to generate an authentication sufficient for assessing trust in the device, such as prior to provisioning the device or otherwise providing access to a trust-dependent service, etc. The processes, operations and other aspects of the method may be facilitated with corresponding instructions stored on computer-readable mediums and executable with processors associated with the device, the another device and the trusted authority. The present invention contemplates its use and application in authenticating any device having capabilities commensurate with those necessary to facilitate the operations contemplated herein, i.e., having suitable interfaces, componentry, hardware, software and other competencies to store readable and non-readable attestations and to facilitate communications and other information exchanges described herein to assess trust in an identity or another representation being made by the device for purposes of obtaining access to an access point or to some other trust dependent service, medium, mechanism, facility, etc.

Block 38 relates to binding attestations to the device intending to operate in accordance with the present invention for purposes of establishing trust in its identity, which may be also be undertaken with any number of additional devices for similar purposes. The binding may include the trusted authority generating an attestation to be stored or kept within a readable element and a non-readable element of the device. The attestations may be data embodying a number or series of bits, a certificate ID, a device ID or other representation capable of being tracked for purposes of assessing alterations, manipulations or misuses thereof, such as to thwart an illegitimate device from masquerading as the device. The attestations may be optionally be identical such that the same attestation may be included on the readable and non-readable elements of the another device to correspondingly generate a readable attestation and a non-readable attestation. The attestations may be associated with and provided to the device at any suitable time and in any sequence, e.g., both of the readable and non-readable attestations may be included on the another device at the time of manufacture or prior to deployment and/or one of the readable and non-readable attestations may be provided at the time of manufacture or prior to the deployment with the other attestation being provided later to correspondingly affect trust associated therewith.

Block 40 relates to comparing attestations associated with the device to generate an authentication sufficient for assessing trust. The comparison may occur with the trusted authority determining whether the readable attestation and the non-readable attestation match, such as through corresponding communications with the device and/or the another device or other independently operable device in proximity thereto. One aspect of the present invention contemplates assessing trust as part of DPP or another provisioning process whereby the another device may have configurator status or other administrative control over the access point and correspondingly be in proximity to the device for purposes of a related user assisting in the authentication. A separate authentication or other process may be used to grant the another device control or suitable rights to the access point such that a measure of trust may be gleaned from proximity of the another device to the device. The another device may be controlled through user inputs and/or commands from the trust authority to read the readable attestation from the readable element of the device and thereafter communicate the readable attestation to the trusted authority. The device may be similarly controlled through user inputs to it and/or through communications with the another device and/or the trusted authority to communicate the non-readable attestation to the another device and/or the trusted authority.

In the event the trusted authority is operating independently of the access point, temporary or limited communications may be undertaken between the trusted authority and the device to facilitate communication of the non-readable attestation thereto, or communications between the device and the another device may be established whereafter the another device may then communicate the non-readable attestation to the trusted authority. The non-readable attestation when relayed to the trusted authority via the another device may be encrypted or otherwise unreadable or unalterable by the another device to prevent it from being manipulated prior to receipt at the trusted authority. The trusted authority may generate the authentication to indicate trust in the device when the readable and non-readable attestations match and to indicate a lack of trust in the device when the readable and non-readable attestations fail to match. The corresponding trust or lack of trust may be relatedly derived from the readable and non-readable attestations having been bounded to the device at the time of manufacture, at the time of deployment, i.e., after manufacture and sale or distribution from the service provider or retailer, or at another suitable instance when the trusted authority has reasonable control over the application of the attestations to the device.

The attestation comparison may be beneficial in ameliorating the probability of a masquerade attack or other operation misusing both of the readable and non-readable attestations due to an improbably of an illicit device knowing the contents of the attestation generated by the trusted authority. The illicit device may have access to the readable attestation, and may optionally use that access to make a copy of the readable attestation, but the secondary assessment of the non-readable attestation, which would be required in accordance with the present invention from the illicit device, may be essentially impossible for the illicit device to accurately steal, particularly if the illicit device is required to communicate the non-readable attestation to the trusted authority as the trusted authority may use a signature or other measure to assure the non-readable attestation is from the device. In the event the readable attestation is non-static or otherwise requires control of the device to be read, such as through corresponding control of a user interface, NFC interface, etc., the trusted authority may selectively direct conveyance of the readable attestation through corresponding control of the device such that an additional level of trust may be gleaned from the illicit device being independent of the another device and thus incapable of communicating the readable attestation in response to instructions from the trusted authority.

Block 42 relates to verifying provisioning or other operations being requested for the device based on trust indicated in the authentication. The verifying may be a manual process whereby the trusted authority provides the authentication to the another device in a manner sufficient for indicating whether the device is believed to be what it asserts to be, i.e., whether the readable and non-readable attestations were determined to match. The trusted authority may transmit a message or other indication of a match or a failure to match to the another device whereat the user may make a corresponding verification input to the another device to indicate whether the provisioning or other operation should be granted. While an automated verification and/or an automated proximity (e.g., signaling range, etc.) is contemplated, the manual verification may be beneficial in assuring continued proximity of the another device or the corresponding user to the device. The verification process may also include requiring the user to select the access point or the service desired for provisioning or access, such as by limiting the selectable access points to those within the administrative rights of the another device. Block 44 relates to automatically provisioning the device for on boarding with the access point other service when the manual verification indicates trust, which may occur through DPP or other exchange of onboarding information between the device and another device and/or access point.

Block 46 relates to reconciling inventory or performing other trust-based inquiries using trust according to the foregoing processing, i.e., through the trusted authority or other entity assessing readable and non-readable attestations from the device or other previously authenticated devices. Block 46 may be reached after provisioning the device or optionally without performing the provisioning/onboarding described above, such as to facilitate reconciling inventory of previously trusted devices and/or devices that may not have been previously trusted but were otherwise already provisioned for access to services. Inventory reconciliation may be periodically performed by network administrators and/or security engineers to assess/discover connection locations for devices in a network, how the devices are being used and for other management related purposes. Inventory reconciliation can be a human intensive process whereby individuals may be required to reconcile discrepancies between inventories generated when onboarding/provisioning devices for network connectivity with independent inventories subsequently generated from polling of the connected devices. The the trust gleaned from binding the attestations to such devices as contemplated herein may be useful in reconciling discrepancies between the onboarding/provisioning inventories and the polling inventories with automated processes for physical verification and discovery processes derive from having the authentication of trust for devices.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for authenticating trust in an identity of a device, the method comprising:
determining a non-readable attestation for the device from a non-readable element of the device;
determining a readable attestation for the device from a readable element of the device;
determining an authentication for the device based on a comparison of the non-readable attestation and the readable attestation, the authentication being sufficient to indicate trust in an identity of the device.

2. The method of claim 1 further comprising performing the comparison at a trust authority operating independently of the device, the trust authority determining the non-readable attestation through communications with the device and determining the readable attestation through separate communications with another device in proximity to the device.

3. The method of claim 2 further comprising transmitting the non-readable attestation from the trusted authority for storage on the non-readable element.

4. The method claim 3 further comprising adding the readable attestation to the readable element in an application process executed independently of the non-readable attestation being transmitted from the trusted authority to the device.

5. The method of claim 2 further comprising the another device optically obtaining the readable attestation from the readable element.

6. The method of claim 2 further comprising the another device wirelessly obtaining the readable attestation from the readable element.

7. The method of claim 2 further comprising:
determining the authentication to be sufficient for provisioning the device to onboard with an access point when the non-readable attestation matches with the readable attestation; and
determining the authentication to be insufficient for provisioning the device to onboard with the access point when the non-readable attestation fails to match with the readable attestation.

8. The method of claim 7 further comprising transmitting a message from the trust authority to the another device for indicating whether the authentication is sufficient or insufficient for provisioning the device to onboard with the access point.

9. The method of claim 8 further comprising executing a provisioning process for the device when the authentication is sufficient, the provisioning process including the device and the another device and/or the access point exchanging information needed to onboard the device with the access point.

10. The method of claim 9 further comprising the provisioning process including a manual verification and an automated onboarding, the manual verification occurring as a function of a user input to the another device verifying the access point for onboarding, the automated onboarding occurring with the another device providing parameters to the device needed for automatically onboarding with the access point without corresponding user input of the parameters to the device.

11. The method of claim 7 further comprising selecting the access point from one more access points associated with the another device, the another device having been previously onboarded with or delegated configurator status for the one or more access points.

12. The method of claim 1 further comprising:
determining an unknown location of the device to coincide with a known location of the another device when the non-readable element matches with the readable element; and
determining the unknown location of the device failing to coincide with the known location of the another device when the non-readable element fails to match with the readable element.

13. The method of claim 1 further comprising:
determining the readable element being unaltered since a time of association with the non-readable element when the non-readable attestation matches with the readable attestation; and
determining the readable element being altered since the time of association with the non-readable element when the non-readable attestation fails to match with the readable attestation.

14. The method of claim 13 further comprising binding the readable attestation and the non-readable attestation to the device prior to deployment of the device such that the time of association occurs prior to deployment.

15. The method of claim 13 further comprising binding the readable attestation and the non-readable attestation to the device after deployment of the device such that the time of association occurs after deployment.

16. The method claim 13 further comprising generating the readable attestation and the non-readable attestation as a number or a series of bits.

17. The method of claim 13 further comprising generating the readable element to include a public key and/or a plurality of attributes associated with the device.

18. A non-transitory computer-readable medium having a plurality of instructions executable with a processor of a trusted authority for authenticating trust in an identity of a device, the plurality of instructions being sufficient for:
generating an attestation for the device;
communicating the attestation for use with a readable element and a non-readable element of the device; and
subsequently generating an authentication for the device based on a comparison of the attestation following receipt from the device and another device in proximity thereto, the another device obtaining the attestation from the readable element, the authentication indicating trust in an identity of the device when the comparison indicates the attestations received from both the device and the another device matching and mistrust in the identity of the device when the comparison indicates the attestations received from both the device and the another device failing to match.

19. An authentication system comprising:
a trusted authority for generating an attestation;
an unidentified device having the attestation included with a readable element and a non-readable element;
an identified device reading the attestation from the readable element; and
wherein the trusted authority generates an authentication for use at the identified device in assessing trust in an identity of the unidentified device based on a comparison of the attestations included on the non-readable element to the attestation read with the identified device from the readable element.

20. The system of claim 19 wherein the identified device executes a provisioning process for automatically onboarding the unidentified device to an access point in response to the authentication indicating trust in the identity of the unidentified device.
